(19) United States
(12) Patent Application Publication
(10) Pub. No.: US 2020/0267277 A1
(43) Pub. Date: Aug. 20, 2020

(54) IMAGES TO COMBINE ORIGINAL LUMINANCE AND PROCESSED CHROMINANCE

(71) Applicant: HEWLETT-PACKARD DEVELOPMENT COMPANY, L.P., Spring, TX (US)

(72) Inventor: Jay S. Gondek, Vancouver, WA (US)

(21) Appl. No.: 16/604,142

(22) PCT Filed: Nov. 10, 2017
(86) PCT No.: PCT/US2017/061017

§ 371 Date: Oct. 9, 2019

(51) Int. Cl. H04N 1/32; G06T 5/00; G06T 5/50; G06T 1/00

(52) U.S. Cl. CPC H04N 1/32267; G06T 5/009; G06T 5/50; G06T 2207/10024; H04N 1/32309; G06T 2207/20221; G06T 1/0021

(57) ABSTRACT

A device includes memory and a processor connected to the memory to execute instructions. The instructions are to determine luminance values of pixels of an original image and to determine chrominance values of pixels of a processed image obtained from performance of an image processing operation on the original image. The instructions are further to combine the luminance values of the pixels of the original image and the chrominance values of the pixels of the processed image to obtain a resultant image.

### BACKGROUND

Digital images are processed for a variety of reasons. Filtering may be used to alter an image. Images may be compressed to reduce storage space or transmission time. An image may be processed to add information, such as by combining the image with another image. A multitude of processing techniques may be used in the digital domain.

### BRIEF DESCRIPTION OF THE DRAWINGS

FIG. 1 is a block diagram of an example device.

FIG. 2 is a schematic diagram of example processing to obtain an example resultant image from example original and processed images.

FIG. 3 is a graph of an example de-gamma curve.

FIG. 4 is a diagram of an example computation of a luminance value.

FIG. 5 is a diagram of an example computation of chrominance values.

FIG. 6 is a diagram of an example computation to transform a pixel from a linear-luminance opponent color space to a linear-luminance component color space.

FIG. 7 is a graph of an example gamma correction curve.

FIG. 8 is a diagram of an example system.

FIG. 9 is a flowchart of an example method.

FIG. 10 is a diagram of another example system.

### DETAILED DESCRIPTION

It is often the case that processing a digital image results in artifacts that are visible to the viewer. Manipulating the chrominance of an image may result in changes to the image's luminance, which tend to be more readily apparent to the viewer. For example, adding a machine-readable digital watermark, which is typically meant to be imperceptible to the human viewer, involves manipulating image chrominance and often has the side effect of creating visible artifacts due to unintended changes in luminance. Image compression may also result in artifacts. In addition, information about the processing performed on the image may be unavailable, such as when an image is sent to a third party for processing, and therefore such information cannot be used to correct the processed image.

An original image may be provided for processing, such as to add a digital watermark. After processing, chrominance values taken from the processed image may be combined with luminance values taken from the original image. The resultant image may contain fewer noticeable artifacts due to using the original luminance values. At the same time, the effect of the processing may be preserved due to use of the chrominance values taken from the processed image. This technique may be implemented in post-processing, so that information about the operation performed on the original image to obtain the processed image is not needed.

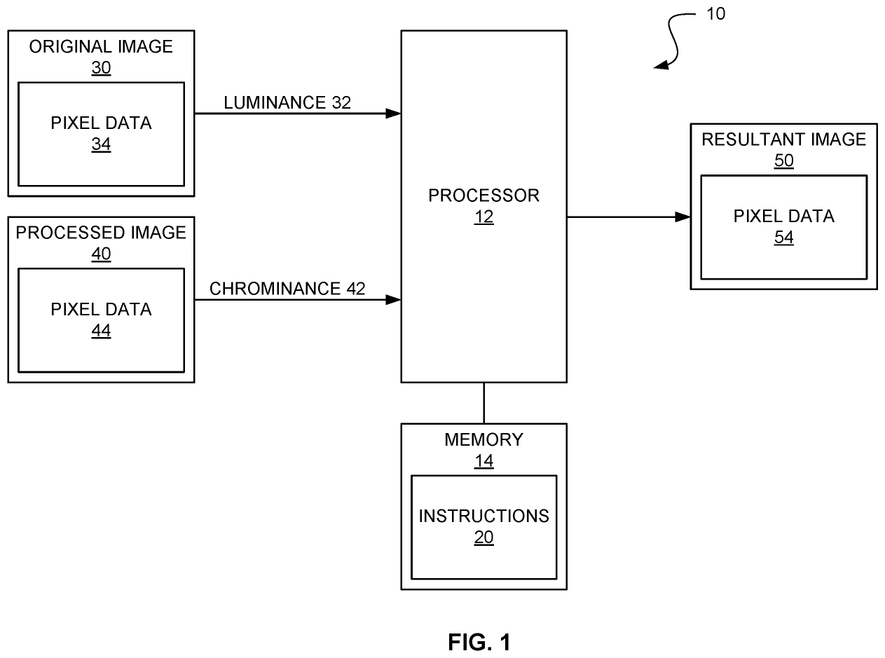

FIG. 1 shows an example device 10. The device 10 includes a processor 12 and memory 14 that are mutually connected.

The processor 12 may include a central processing unit (CPU), a graphics processing unit (GPU), a microcontroller, a microprocessor, a processing core, a field-programmable gate array (FPGA), or similar device capable of executing instructions. The processor 12 may cooperate with the memory 14 to execute instructions. The memory 14 may include a non-transitory machine-readable storage medium that may be any electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, and the like. The machine-readable storage medium may be encoded with executable instructions.

The device 10 further includes instructions 20 stored in the memory 14 and executable by the processor 12. The instructions 20 are to cause the processor 12 to combine data from an original image 30 with data from a processed image 40 to obtain a resultant image 50. The processed image 40 may be previously obtained by performing an image processing operation on the original image 30. Examples of image processing operations include compression, filtering, transformation, color balancing, color restoration, red-eye removal, aesthetic color effects and filters (e.g., sepia-tone or rainbow colors), and applying a digital watermark, and any number and type of image processing operations may be performed on the original image 30 to obtain the processed image 40. As such, the instructions 20 may represent a post-processing operation.

The instructions 20 are to determine luminance values 32 of pixels represented by pixel data 34 of the original image 30. All of the pixels or a subset thereof may be referenced to determine the luminance values 32.

The instructions 20 may constrain the luminance values 32 to conform to a constant-luminance color space. This may be referred to as an iso-luminance opponent color space that includes color opponents, which may be designated as Cb and Cr. A luminance component, which may be designated as Y, may be provided such that any colors having equal luminance value Y will have a matching human-perceived lightness. The constant-luminance color space may also be a linear-luminance color space, in that the color space may be digitally encoded with steps of equal luminance difference. For example, each of the 256 steps of an 8-bit luminance value may correspond to the same approximate luminance difference, as perceived by a human being. Luminance, as discussed herein, is not the same as luma as used in, for example, Joint Photographic Experts Group (JPEG) image processing techniques. A typical JPEG image uses a YCbCr color space, where Y is luma, that does not have iso-luminance and does not have linear luminance.

In other examples, the instructions 20 may constrain the luminance values 32 to conform to an International Commission on Illumination (CIE) XYZ color space, a Yxy color space, or similar color space that has iso-luminance and linear luminance.

The instructions 20 are further to determine chrominance values 42 of pixels represented by pixel data 44 of the processed image 40. The instructions 20 may constrain the chrominance values 42 to conform to a constant luminance color space, which may be the same color space that constrains the luminance values 32.

The chrominance values 42 and luminance values 32 may have the same spatial resolution. For instance, the original image 30, processed image 40, and resultant image 50 may have the same W by H size in pixels. As such, W*H luminance values 32 may be determined (one for each pixel) and W*H chrominance values 42 for each color opponent may be determined. If the resultant image 50 is to have a size different from one or both of the original image 30 and the processed image 40, then the luminance values 32 and chrominance values 42 may be spatially up-sampled or down-sampled to the resolution of the resultant image 50. The resolution of the resultant image 50 need not be the same for luminance and chrominance. That is, the chrominance values 42 may be subsampled at a resolution lower than the luminance values 32, for example.

The instructions 20 are further to combine the luminance values 32 taken from the original image 30 with the chrominance values 42 taken from the processed image 40 to obtain pixel data 54 for the resultant image 50. As such, the effect of the image processing operation performed on the original image 30 to obtain the processed image 40 is retained in the chrominance information of the resultant image 50. At the same time, the luminance information of the processed image 40 is discarded and instead the luminance information of the original image 30 is used in the resultant image 50, so as to reduce or eliminate the presence of artifacts or other undesirable side effects of the image processing operation that may exist in the luminance information of the processed image 40.

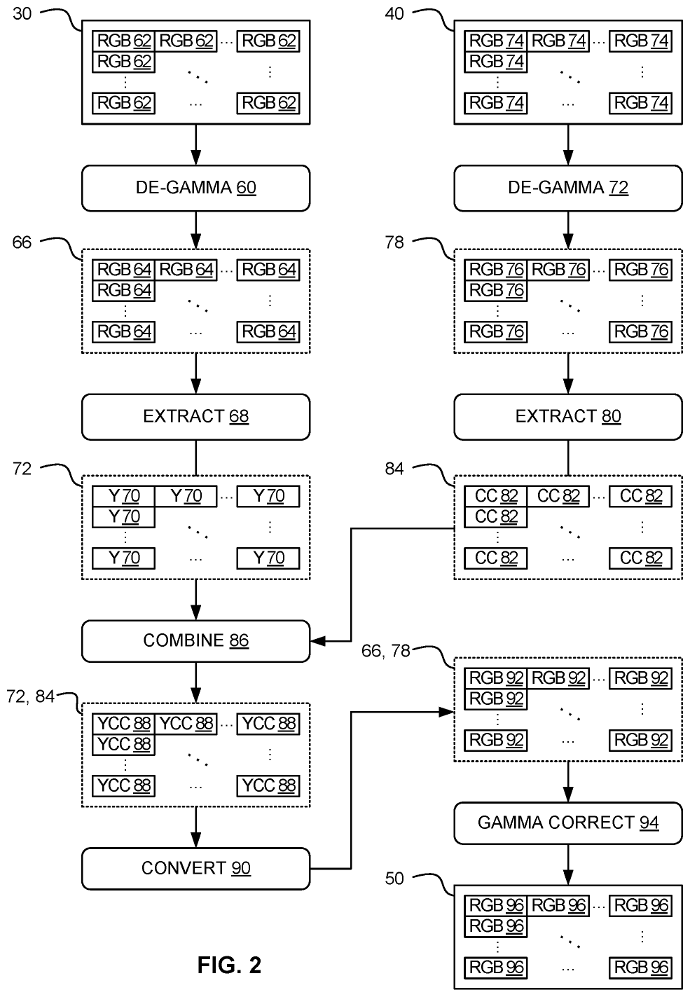

FIG. 2 shows processing that may be performed on an original image 30 and a processed image 40 to obtain a resultant image 50. The processing may be performed by a device, such as the devices discussed herein. The processing may be implemented by processor-executable instructions.

An original image 30 is provided to an image processing operation that generates the processed image 40. Various kinds of image processing operations, such as adding a digital watermark, are described elsewhere herein. The original image 30 and processed image 40 may conform to a color space, such as a Red Green Blue (RGB) color space, a standard RGB (sRGB) color space, or similar. The original image 30 and processed image 40 may conform to the same or different color spaces. Any suitable image format may be used for the original image 30 and processed image 40, such as a JPEG format, a Portable Network Graphics (PNG) format, a Tagged Image File (TIF) format, a Portable Document Format (PDF), and similar.

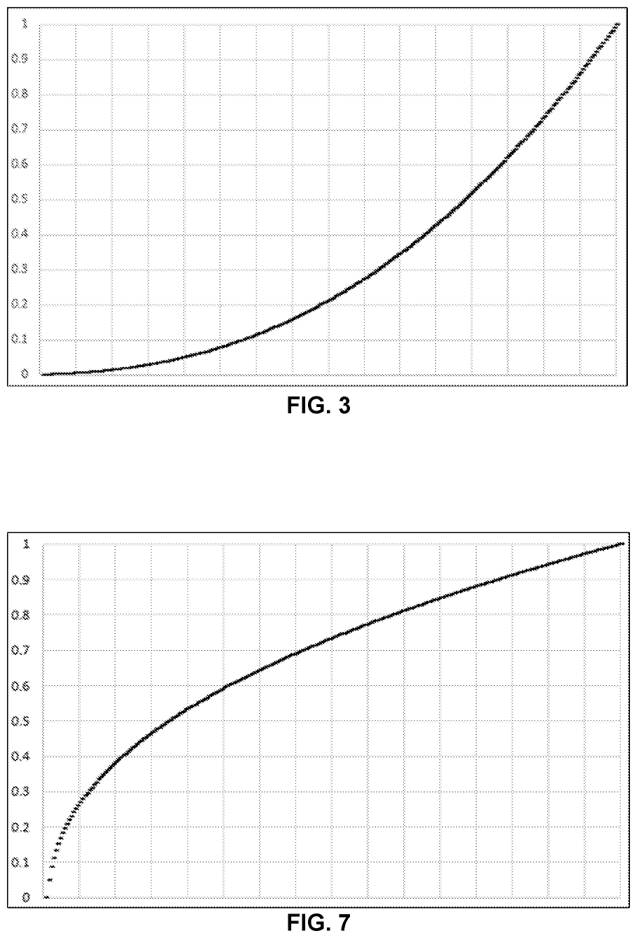

At block 60, a gamma correction may be removed from pixels 62 of the original image 30 to obtain original pixels 64 that conform to a linear-luminance component color space 66. This may be referred to as a de-gamma operation. Each pixel 62 of the original image 30 may be mapped to a set of points that define a de-gamma curve. An example digitized de-gamma curve is shown in FIG. 3, in which 256 discrete values are provided for 256 possible input values for each 8-bit color component of the pixels 64.

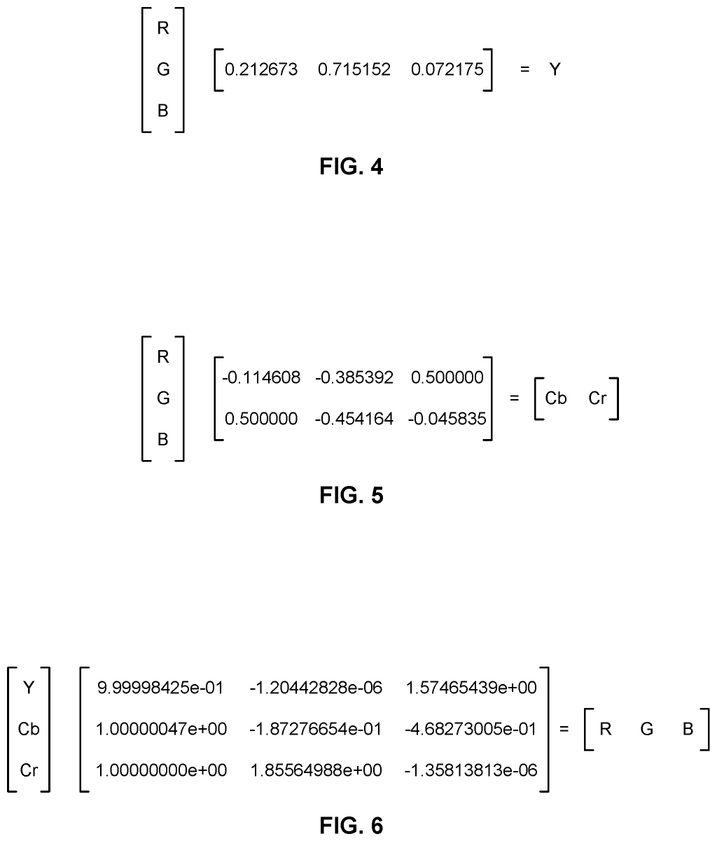

At block 68, luminance values 70 may be extracted from the original pixels 64 in the linear-luminance component color space 66. This may include converting the original pixels 64 in the linear-luminance component color space 66 into luminance values 70 of a linear-luminance opponent color space 72. The linear-luminance opponent color space 72 may be a color space that defines the difference between any two adjacent digital luminance values as having equal luminance difference, as perceived by a human, and that defines any colors having equal digital luminance value as having a matching human-perceived lightness. FIG. 4 shows an example vector multiplication to convert an original pixel 64 in an RGB linear-luminance component color space 66 to a luminance value, Y, in the linear-luminance opponent color space 72. The numerical values shown are examples and other values may be used.

At block 72, a gamma correction may be removed from the pixels 74 of the processed image 40 to obtain processed pixels 76 in a linear-luminance component color space 78, which may be the same as the linear-luminance component color space 66 used for the original image 30. Each pixel of the processed image 40 may be mapped to a set of points that define a de-gamma curve, which may be the same de-gamma curve used at block 60 for the original image 30.

At block 80, chrominance values 82 may be extracted from the processed pixels 76 in the linear-luminance component color space 78. This may include converting the processed pixels 76 in the linear-luminance component color space 78 into opponent color values of a linear-luminance opponent color space 84, which may be the same color space as the linear-luminance opponent color space 72 used for the original image 30. FIG. 5 shows an example matrix multiplication to convert a processed pixel 76 in an RGB linear-luminance component color space 78 to opponent color values Cb, Cr in the linear-luminance opponent color space 84. The numerical values shown are examples and other values may be used.

At block 86, the luminance values 70 and the opponent color values 82 may be combined to obtain resultant pixels 88, which may conform to a linear-luminance opponent color space, such as a color space 72, 84 of the original or processed image. The outputs of the vector/matrix operations shown in FIGS. 4 and 5 may be combined to, for example, define each pixel as having Y, Cb, and Cr values, where Cb and Cr are respective blue-difference and red-difference chroma components and where Y represents constant and linear luminance.

At block 90, the resultant pixels 88 in the linear-luminance opponent color space may be converted to a linear-luminance component color space, such as the color space 66, 78 of the original or processed pixels, to obtain resultant pixels 92. The resultant pixels 92 may conform to an RGB color space. An example matrix multiplication to convert a pixel 88 in a linear-luminance opponent color space to a pixel 92 in a linear-luminance component color space is shown in FIG. 6. The numerical values shown are examples and other values may be used.

At block 94, a gamma correction may be applied to the resultant pixels 92 to obtain gamma-corrected resultant pixels 96. The gamma-corrected resultant pixels 96 may conform to the same color space at the original image 30, the processed image 40, or both images 30, 40 if the same color space was used. An example digitized gamma correction curve is shown in FIG. 7, in which 256 discrete values are provided for 256 possible input values for each 8-bit color component of the resultant pixels 92.

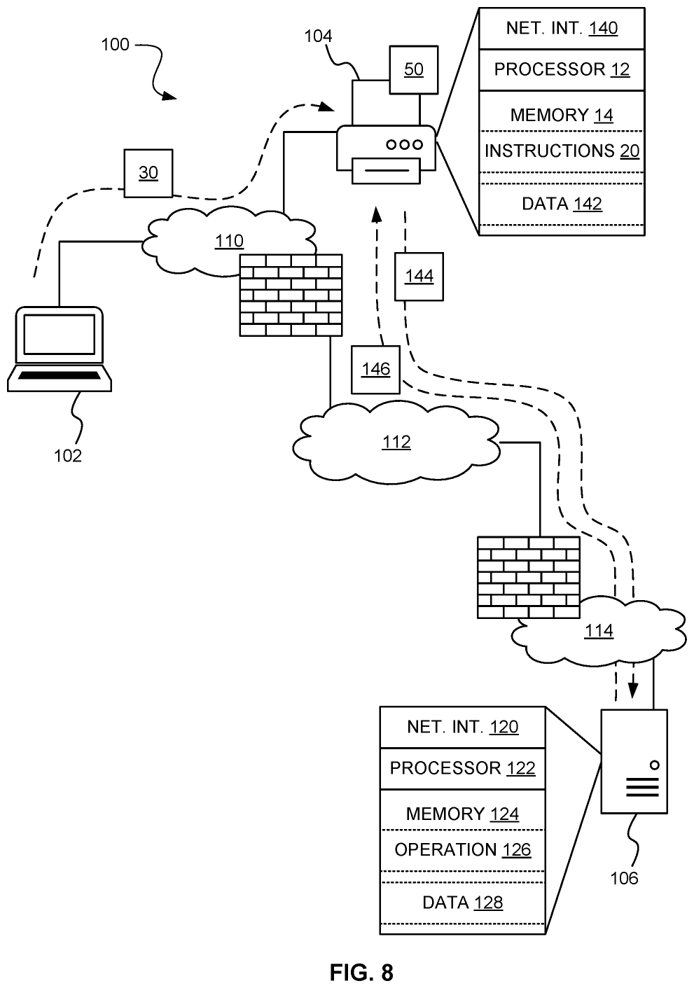

FIG. 8 shows an example system 100. The system 10 may include a computer device 102, an image processing device 104, and remote computer device 106, which may be an image processing server.

The computer device 102 and the image processing device 104 may be connected by a computer network 110, such as a local-area network (LAN) that may be protected from a wide-area network 112, such as the internet, by a firewall.

The computer device 102 may be a desktop computer, notebook computer, tablet computer, smartphone, or similar. The computer device 102 may include a processor and memory of the kinds discussed elsewhere herein. The computer device 102 may be the source of data that is to be transmitted to the image processing device 104 via the network 110. This may be represented by original image 30. For example, the computer device 102 may generate a document that is sent to image processing device 104 to be printed to a physical medium, such as paper, as original image 30.

The remote computer device 106 may be to perform an image processing operation, such as applying a digital watermark to an image or any of the other image processing operations discussed herein. Specifics about the image processing operation performed by the remote computer device 106 may be unknown to the image processing device 104.

The remote computer device 106 may connect to the wide-area network 112 via a local-area network 114 that is firewall protected from the wide-area network 112. The remote computer device 106 may include a network interface 120 to communicate data with the computer network 114 and a processor 122 and memory 124, such as the kinds described elsewhere herein. The memory 124 may store instructions to implement the image processing operation 126 and related data 128.

The image processing device 104 may be a printer, a computer device, a server, or similar. The image processing device 104 may include a network interface 140 to communicate data with the computer network 110. The image processing device 104 may further include a processor 12, memory 14, and instructions 20.

The instructions 20 at the image processing device 104 may be to receive an original image 30, or data defining an original image, via the network interface 140 from, for example, a computer device 102.

The instructions 20 may further be to store luminance values of the original image 30 in the memory 14. Luminance values may be extracted from the original image 30 and stored as data 142 in the memory 14. The instructions 20 may convert the original image 30 to a linear-luminance opponent color space and may obtain the luminance values 142 from the linear-luminance opponent color space. The entire original image 30, or an image derived therefrom, may be stored in memory 14 to store the luminance values.

The instructions 20 may further be to transmit original chrominance values 144 of the original image 30 to the remote computer device 106 from the network interface 140 via the networks 101, 112, 114. The chrominance values 144 may be sent to the remote computer device 106 by sending the entire original image 30. In other examples, chrominance values 144 may be extracted from the original image 30 and sent without luminance information to the remote computer device 106. Image compression may be applied and chrominance information transmitted may be compressed more than luminance information transmitted, if any.

The instructions 20 may further be to receive processed chrominance values 146 from the remote computer device 106 after the remote computer device 106 has performed the imaging operation on the provided chrominance values 144 to obtain the processed chrominance values 146. Processed chrominance values 146 may be transmitted by the remote computer device 106 to the image processing device 104 in the form of a processed image 40 that may also include luminance information. Luminance information need not be sent by the remote computer device 106, as it will be replaced by the original luminance information.

The instructions 20 may further be to combine the stored original luminance values 142 with the received processed chrominance values 146 to obtain a resultant image 50. This may include converting the processed chrominance values 146 to a linear-luminance opponent color space and extracting opponent color values that may be combined with the stored luminance values 142.

The resultant image 50 may be further processed by the image processing device 104. For example, the image processing device 104 may be a printer that includes a print engine, and the resultant image 50 may be printed to a physical print medium. The resultant image 50 may be transmitted to the computer device 102.

Images or luminance/chrominance values thereof may be compressed at various points in the system 10. For example, the instructions 20 at the image processing device 104 may be to compress the original image 30 to obtain a compressed original image, which is then transmitted to the remote computer device 106 to convey the original chrominance information. The original image 30 may be compressed by the computer device 102. The processed chrominance values 146, which may be transmitted from the remote computer device 106 to the image processing device 104 as an image, may be compressed by the remote computer device 106 prior to transmission. A compressed image may be further compressed. The image processing device 104 may use the luminance information 142 in the resultant image 50 to reduce artifacts generated by compression of information communicated between the image processing device 104 and the remote computer device 106. For example, a high level of JPEG compression may be used for image information communicated between the image processing device 104 and the remote computer device 106, as original luminance information is to be restored at the image processing device 104.

An image smaller than the original image 30 may be transmitted to the remote computer device 106, as luminance information may be omitted or compression error in luminance information may be tolerated. The image processing operation (e.g., watermarking) and image compression performed by the remote computer device 106 may be performed irrespective of any degree of error introduced to the luminance information, as the original luminance information will be restored at the image processing device 104. In other words, any degradation of luminance information during compression, transmission, and imaging processing operation performed with respect to the remote computer device 106 may be neglected.

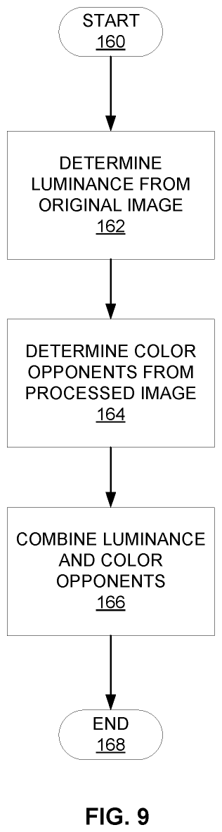

FIG. 9 shows a method to obtain a resultant image from an original image and a processed image. The method may be performed by any of the devices discussed herein or by other devices. The method may be implemented by processor-executable instructions stored in a memory.

The method starts at block 160 with an original image and a processed image that is related to the original image by a previously performed image processing operation, such as the application of a digital watermark or other operation discussed herein.

At block 162, luminance values are determined from a linear-luminance opponent color space applied to the original image. This may include removing a gamma correction from the original image and mapping original pixel data from an original color space to the linear-luminance opponent color space.

At block 164, opponent color values are determined from a linear-luminance opponent color space applied to the processed image. This may include removing a gamma correction from the processed image and mapping processed pixel data from a processed color space to the linear-luminance opponent color space.

The linear-luminance opponent color spaces in blocks 162 and 164 may be the same.

At block 166, the luminance values of the original image are combined with the opponent color values of the processed image to obtain a resultant image. This may include pixelwise combining of luminance values with opponent color values to obtain pixel data in the linear-luminance opponent color space and then converting the pixel data to another color space, such as the original color space, processed color space, or another color space. A gamma correction may be applied.

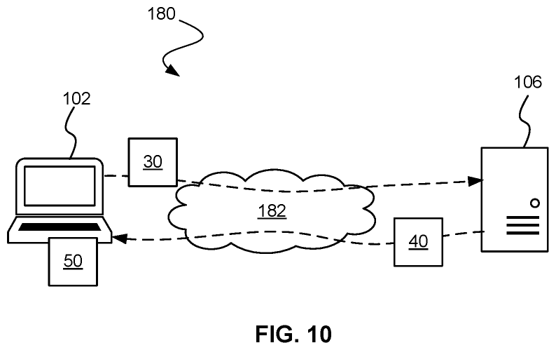

FIG. 10 shows an example system 180. The system 180 may include a computer device 102 and a remote computer device 106, such as an image processing server. The devices 102, 106 are mutually connected through a computer network 182, which may include a local-area network, wide-area network, the internet, or similar.

The computer device 102 may be to generate an original image 30 that may be transmitted via the network 182 to the remote computer device 106, which may perform an imagining operation, such as applying a digital watermark, on the original image 30 to obtain a processed image 40. The remote computer device 106 may transmit the processed image 40 to the computer device 102 via the network 182.

The original image 30 includes chrominance information that is processed by the remote computer device 106 to obtain the processed image 40. In other examples, the chrominance information is extracted from the original image 30 and transmitted to the remote computer device 106 to be processed. The original image 30 or chrominance information or chrominance information thereof may be compressed.

The processed image 40 includes chrominance information that is the result of the image processing operation performed by the remote computer device 106. Luminance information may be discarded from the processed image 40. In other examples, processed chrominance information without luminance information is transmitted from the remote computer device 106 to the computer device 102.

The computer device 102 may further be to combine luminance information from the original image 30 with chrominance information received in the processed image 40 from the remote computer device 106 to obtain a resultant image 50. This may include converting the images 30, 40 into a linear-luminance opponent color space and combining luminance values from the converted original image 30 with color opponent values from the converted processed image 40.

It should be apparent from the above that the presence of visual artifacts in an image due to an image processing operation may be reduced or eliminated, even when specific information about the image processing operation is unknown. In the case of an image processing operation that includes applying a digital watermark to an image, the watermark may be made difficult to perceive by the human eye, such as invisible or nearly so, while retaining its machine-readable characteristics. A remote server, such as one operated by a third party, may be used for the image processing operation, while a local post-processing operation may be performed to restore the original luminance channel, and thereby restore some or all of the original human-perceptible quality to the image.

It should be recognized that features and aspects of the various examples provided above can be combined into further examples that also fall within the scope of the present disclosure. In addition, the figures are not to scale and may have size and shape exaggerated for illustrative purposes.

1. A device comprising:
memory;
a processor connected to the memory to execute instructions, the instructions to determine luminance values of pixels of an original image and to determine chrominance values of pixels of a processed image obtained from performance of an image processing operation on the original image, the instructions further to combine the luminance values of the pixels of the original image and the chrominance values of the pixels of the processed image to obtain a resultant image.

2. The device of claim 1, wherein the instructions are further to remove a gamma correction from the pixels of the original image to obtain original pixels in a linear-luminance component color space, and further to extract the luminance values from the original pixels in the linear-luminance component color space.

3. The device of claim 2, wherein the instructions are further to extract the luminance values by converting the original pixels in the linear-luminance component color space into luminance values of a linear-luminance opponent color space.

4. The device of claim 3, wherein the instructions are further to remove a gamma correction from the pixels of the processed image to obtain processed pixels in the linear-luminance component color space, and further to extract the chrominance values from the processed pixels in the linear-luminance component color space.

5. The device of claim 4, wherein the instructions are further to extract the chrominance values by converting the processed pixels in the linear-luminance component color space into opponent color values of the linear-luminance opponent color space.

6. The device of claim 5, wherein the instructions are further to combine the luminance values and the opponent color values of the linear-luminance opponent color space to obtain resultant pixels of the resultant image by converting the luminance values and the opponent color values into the linear-luminance component color space.

7. The device of claim 6, wherein the instructions are further to apply a gamma correction to the resultant pixels.

8. The device of claim 1, wherein the image processing operation is to apply a digital watermark.

9. A device comprising:
a network interface;
memory;
a processor connected to the network interface and the memory to execute instructions, the instructions to store luminance values of an original image in the memory, transmit chrominance values of the original image to a remote computer device via the network interface, receive processed chrominance values from the remote computer device via the network interface, and combine the luminance values and the processed chrominance values to obtain a resultant image

10. The device of claim 9, wherein the instructions are further to obtain the luminance values of the original image from a linear-luminance opponent color space applied to the original image, and further to obtain opponent color values from the linear-luminance opponent color space applied to the processed chrominance values to combine with the luminance values to obtain the resultant image.

11. The device of claim 9, wherein the instructions are further to receive the original image via the network interface.

12. The device of claim 9, further comprising a print engine to print the resultant image to a physical print medium.

13. The device of claim 9, wherein the instructions are further to transmit the original image containing the chrominance values to the remote computer device via the network interface.

14. The device of claim 13, wherein the instructions are further to compress the original image to obtain a compressed original image and further to transmit the compressed original image containing the chrominance values to the remote computer device via the network interface.

15. A method comprising:
determining luminance values from a linear-luminance opponent color space applied to an original image;
determining opponent color values from the linear-luminance opponent color space applied to a processed image, the processed image related to the original image by a previously performed image processing operation; and
combining the luminance values of the original image with the opponent color values of the processed image to obtain a resultant image.
